(19) United States
(12) Patent Application Publication
(10) Pub. No.: US 2008/0312121 A1
(43) Pub. Date: Dec. 18, 2008

(54) Liquid Surface Active Compositions

(76) Inventors: Kirk Herbert Raney, Houston, TX (US); Paul Gregory Shpakoff, Houston, TX (US)

Correspondence Address: SHELL OIL COMPANY, P O BOX 2463, HOUSTON, TX, 772522463, US

(21) Appl. No.: 12/065,921

(22) PCT Filed: Sep. 6, 2006
(86) PCT No.: PCT/US2006/034513

§ 371 Date: Aug. 8, 2008

Related U.S. Application Data
(60) Provisional application No. 60/714,994, filed on Sep. 8, 2005.
(60) Provisional application No. 60/729,967, filed on Oct. 25, 2005.

(51) Int. Cl. C11D 1/68

(52) U.S. Cl. 510/340

(57) ABSTRACT

A liquid surface active composition which is comprised of an alcohol ethoxysulfate, an alcohol ethoxylate, c) an additive which is triethanolamine or a diol comprised of carbon, oxygen, and hydrogen atoms and which has a molecular weight of 75 to 225, and water.

### FIELD OF THE INVENTION

This invention relates to liquid surface active compositions comprising a mixture of an alcohol ethoxysulfate and an alcohol ethoxylate.

### BACKGROUND OF THE INVENTION

The manufacture and use of synthetic laundry detergents containing mixtures of nonionic and anionic surfactants has been well documented. Liquid surfactant compositions are well known in the field of laundry detergents and, whether for domestic or industrial applications, practically all of the available formulations are solutions of one or more surface active materials (surfactants) in water, together with an organic solvent if necessary.

Early on in the development of these surfactants, such formulations usually contained only about 10 to 45 weight percent (wt %) surface active matter. The problems inherent in the use of relatively dilute formulations, such as the difficulty and high cost of transporting the formulation from its point of manufacture to its point of sale, led to the conclusion that it would have been very advantageous from the standpoint of shipping costs to prepare more concentrated formulations.

Alcohol ethoxysulfates provide good detergency and foamability and are thus highly valued in household laundry products as part of mixed surfactant systems. Alcohol ethoxysulfates have a drawback in that they have a strong tendency to form gels in formulations having concentrations greater than 30 percent by weight. It was found that the gel formation could be reduced by incorporating approximately 14 percent by weight of ethanol into 60 percent by weight surface active solutions of alcohol ethoxysulfates. However, since ethanol is flammable and combustible, such compositions could not be used in the production of spray dried or dry blended laundry powders where the flammability and combustibility of ethanol represents a significant processing hazard.

U.S. Pat. Nos. 5,209,874 and 5,215,683, which are herein incorporated by reference in their entirety, provided an alcohol ethoxysulfate liquid surface active composition which did not have such flammability and combustibility problems. These patents describe liquid surface active compositions wherein the alcohol ethoxysulfate is used in connection with an alcohol ethoxylate in place of the ethanol. These inventions allowed the production of substantially gel free alcohol ethoxysulfate liquid surface active compositions.

It has since been recognized that at high concentrations of alcohol ethoxysulfate, these compositions exhibit other shipping problems. Specifically, the low flowability of these materials at high concentrations of the alcohol ethoxysulfate (for example, from about 40 percent by weight or higher) makes it difficult to remove the liquid surface active composition from the containers in which it is shipped, especially in the case of tank cars. These compositions may exhibit unacceptably high viscosity. The viscosity can be reduced by introducing shear to the mixture (i.e., by stirring it) but that requires energy and thus more costs.

### SUMMARY OF THE INVENTION

The present invention relates to a liquid surface active composition which is comprised of an alcohol ethoxysulfate; an alcohol ethoxylate; an additive which is selected from the group consisting of triethanolamine, a diol comprising carbon, oxygen, and hydrogen atoms and which has a molecular weight of from 75 to 225; and a mixture of 1,3-propanediol and triethanolamine; and water.

In one embodiment, the liquid surface active composition comprises:
a) at least 40 (preferably 40 to 70, most preferably 50 to 70) percent by weight of the total composition of the alcohol ethoxysulfate;
b) at least 10 (preferably 10 to 50, most preferably 10 to 30) percent by weight of the total composition of the alcohol ethoxylate;
c) at least 4 (preferably 8 to 16) percent by weight of the total composition of an additive which is selected from the group consisting of triethanolamine, a diol comprised of carbon, oxygen, and hydrogen atoms and which has a molecular weight of from 75 to 225, preferably from 100 to 160, and a mixture of 1,3-propanediol and triethanolamine; and
d) water.

In another embodiment, the liquid surface active composition is comprised of:
a) at least 40 (preferably 40 to 70, most preferably 50 to 70) percent by weight of the total composition of an alcohol ethoxysulfate;
b) at least 10 (preferably 10 to 50, most preferably 10 to 30) percent by weight of the total composition of an alcohol ethoxylate;
c) at least 4 (preferably 8 to 16) percent by weight of the total composition of an additive selected from the group consisting of diethylene glycol, triethylene glycol, tetraethylene glycol, and a mixture of 1,3-propanediol and triethanolamine, wherein diethylene glycol and triethylene glycol are preferred and triethylene glycol is the most highly preferred additive; and
d) water.

### BRIEF DESCRIPTION OF THE DRAWINGS

FIG. 1 shows the detailed viscosity/shear rate plots for the triethylene glycol and 1,3-propanediol/triethanol amine systems tested in the examples in the temperature range of interest.

### DETAILED DESCRIPTION OF THE INVENTION

This invention relates to a liquid surface active composition comprising an alcohol ethoxysulfate component, an alcohol ethoxylate component, and an additive for decreasing the viscosity of the composition. As discussed above, these compositions have unacceptably high viscosity for some circumstances when they must be shipped. The use of the additive of this invention helps in the solution of this problem by actually lowering the viscosity of the total composition from that of the composition without the additive.

### Component a)

The general class of alcohol ethoxysulfates of the present invention is characterized by the chemical formula

R′—O—(CH₂—CH₂O)—SO₃M (I)

wherein R′ is a straight-chain or branched-chain alkyl group having in the range of from 8 to 18 carbon atoms or an alkylaryl group having an alkyl moiety having from 8 to 12, preferably 8 to 10 carbon atoms; x represents the average number of oxyethylene groups per molecule and is in the range of from 1 to 12, preferably from 2 to 9 and more preferably from 2 to 5 (in the present invention, the alcohol ethoxysulfates preferably have an average number of oxyethylene groups in the lower end of the range of 1 to 12); and M is a cation selected from an alkali metal ion, an ammonium ion, and mixtures thereof. R′ is preferably substantially straight-chain alkyl, that is, at least 50 percent, preferably at least 85 percent, of the alkyl R′ groups in the instant composition are straight chain. It is understood that R′ may be substituted with any substituent which is inert in the composition of the present invention such as, for example, halo groups.

In one embodiment, the alcohol ethoxysulfates are derivatives of primary or secondary alcohols of carbon number ranging from 8 to 18. The alcohol precursors of the alcohol ethoxysulfate are straight-chain alcohols or are of a branched-chain structure. The alcohol precursors utilized to make the alcohol ethoxysulfate component preferably have from 8 to 15 carbon atoms, and more preferably, from 12 to 15 carbon atoms. Alcohols which are suitable for ethoxylation to form an alcohol ethoxylate which can then be subjected to a sulfation procedure to form the alcohol ethoxysulfate component of the composition include coconut fatty alcohols, tallow fatty alcohols, and the commercially available long-chain synthetic fatty alcohol blends, e.g., the C₁₂ to C₁₅ alcohol blends available, for example, as NEODOL 25 alcohol (available from Shell Chemical Company), the C₁₂ to C₁₄ alcohol blends available under the mark ALFOL 12-14 (Sasol), and the C₁₂ to C₁₃ alcohol blends available, for example, as NEODOL 23 alcohol. NEODOL and ALFOL are registered trademarks.

The alcohol ethoxysulfate component may typically be prepared by first reacting the alcohol with 1 to 12 moles of ethylene oxide per mole of alcohol to form an alcohol ethoxylate product. Thereafter, these alcohol ethoxylate products may be sulfated with a suitable sulfating reagent, and the resulting sulfated product mixture may be neutralized with an aqueous alkali metal solution.

Suitable sulfation procedures include sulfur trioxide (SO₃) sulfation, chlorosulfonic acid (ClSO₃H) sulfation and sulfamic acid (NH₂SO₃H) sulfation, with sulfur trioxide sulfation being preferred. A typical sulfur trioxide sulfation procedure may include contacting liquid alcohol ethoxylate and gaseous sulfur trioxide at atmospheric pressure in the reaction zone of a falling film sulfator cooled by water at a temperature in the range of from 25° C. to 70° C. to yield the sulfuric acid ester of alcohol ethoxylate. The sulfuric acid ester of the alcohol ethoxylate then exits the falling film column and may be neutralized with an alkali metal solution, e.g., sodium or potassium hydroxide, or with ammonium hydroxide, to form the alcohol ethoxysulfate salt.

Specific alcohol ethoxysulfates which may be used in the composition of the present invention include sulfated ethoxylate fatty alcohols, preferably linear primary or secondary alcohols with C₈ to C₁₈, preferably C₁₂ to C₁₅, alkyl groups and an average of 1 to 12, preferably 2 to 9, and more preferably 2 to 5, moles of ethylene oxide per mole of alcohol, and sulfated ethoxylated alkylphenols with C₈ to C₁₂ alkyl groups, preferably C₈ to C₁₀ alkyl groups and an average of 1 to 12 moles of ethylene oxide per mole of alkylphenol. The preferred class of alcohol ethoxysulfates is the sulfated linear ethoxylated alcohols, such as the C₁₂ to C₁₅ alcohols ethoxylated with an average of from 2 to 9 moles of ethylene oxide. A most preferred alcohol ethoxysulfate is prepared by sulfating a C₁₂-C₁₅ alcohol ethoxylated with 3 moles of ethylene oxide (one example of such a product is sold by Stepan under the mark STEOL CS-330).

In a preferred embodiment, the alcohol ethoxysulfate component has a lower average number of oxyethylene units per molecule than the alcohol ethoxylate component.

The alcohol ethoxysulfate may comprise at least 40 percent by weight of the aqueous liquid surface active composition. In another embodiment, the amount of alcohol ethoxysulfate present in the composition may range from 40 percent by weight to 70 percent by weight of the total composition, preferably from 45 percent by weight to 70 percent by weight, and more preferably from 50 percent by weight to 70 percent by weight.

### Component b)

The alcohol ethoxylate may comprise at least 10 percent by weight of the aqueous liquid surface active composition.

In another embodiment, the amount of alcohol ethoxylate present in the composition of the present invention may range from 10 percent by weight to 50 percent by weight of the total composition, preferably from 10 percent by weight to 40 percent by weight, and more preferably from 10 percent by weight to 30 percent by weight.

The general class of alcohol ethoxylates of the present invention is characterized by the chemical formula

R(CHH₂O)ₙ—H (II)

wherein R is a straight-chain or branched-chain alkyl group having in the range of from 8 to 18 carbon atoms or an alkylaryl group having an alkyl moiety having from 8 to 12 carbon atoms; and n represents the average number of oxyethylene groups per molecule and is in the range of from 1 to 12, preferably from 5 to 12 and more preferably from 9 to 12 (in the present invention, the alcohol ethoxylates preferably have an average number of oxyethylene groups in the higher end of the range of 1 to 12). The alkyl group can have a carbon chain which is straight or branched, and the ethoxylate component can be a combination of straight-chain and branched molecules. Preferably, R is preferably substantially straight-chain alkyl, that is, at least 85 percent of the R groups in the instant composition are straight chain. If is understood that R can be substituted with any substituent which is inert such as, for example, halo groups.

Ethoxylates within this class may conventionally be prepared by the sequential addition of ethylene oxide to the corresponding alcohol (ROH) in the presence of a catalyst. The alcohol ethoxylate component of this invention may preferably be derived by ethoxylation of primary or secondary, straight chain or branched alcohols. Suitably, the alcohols have from 8 to 18 carbon atoms, preferably from 9 to 15 carbon atoms, and more preferably from 12 to 15 carbon atoms. The most common ethoxylates in this class and the ones which are particularly useful in this invention are the primary alcohol ethoxylates, i.e., compounds of formula II in which R is an alkyl group and the —O—(CH₂—H₂O)ₙ—H ether substituent is bound to a primary carbon of the alkyl group.

Alcohols which are suitable for ethoxylation to form the alcohol ethoxylate component of this invention include coconut fatty alcohols, tallow fatty alcohols, and the commercially available synthetic long-chain fatty alcohol blends, e.g., the C₁₂ to C₁₅ alcohol blends available, for example, as NEODOL 25 alcohol (available from Shell Chemical Company), the C₁₂ to C₁₄ alcohol blends available, for example, under the mark ALFOL 12-14 (Sasol), and the C₁₂ to C₁₃ alcohol blends available, for example, as NEODOL 23 alcohol.

Suitable alcohol ethoxylates may be prepared by adding to the alcohol or mixture of alcohols to be ethoxylated a calculated amount, e.g., from 0.1 percent by weight to 0.6 percent by weight, preferably from 0.1 percent by weight to 0.4 percent by weight, based on total alcohol, of a strong base, typically an alkali metal or alkaline earth metal hydroxide such as sodium hydroxide or potassium hydroxide, which serves as a catalyst for ethoxylation. The resulting mixture is dried, as by vapor phase removal of any water present, and an amount of ethylene oxide calculated to provide from 1 mole to 12 moles of ethylene oxide per mole of alcohol is then introduced and the resulting mixture is allowed to react until the ethylene oxide is consumed, the course of the reaction being followed by a decrease in reaction pressure.

The ethoxylation may typically be conducted at elevated temperatures and pressures. Suitable reaction temperatures may range from 120° C. to 220° C. with the range of from 140° C. to 160° C. being preferred. A suitable reaction pressure may be achieved by introducing to the reaction vessel the required amount of ethylene oxide which has a high vapor pressure at the desired reaction temperature. For considerations of process safety, the partial pressure of the ethylene oxide reactant may preferably be limited, for instance, to less than 520 kPa, and/or the reactant may preferably be diluted with an inert gas such as nitrogen, for instance, to a vapor phase concentration of 50 percent or less. The reaction may, however, be safely accomplished at greater ethylene oxide concentration, greater total pressure and greater partial pressure of ethylene oxide if suitable precautions, known to the art, are taken to manage the risks of explosion. A total pressure of between 270 and 760 kPa, with an ethylene oxide partial pressure between 100 and 420 kPa, is particularly advantageous, while a total pressure of between 450 and 720 kpa, with an ethylene oxide partial pressure between 240 and 450 kPa, is considered more advantageous. The pressure serves as a measure of the degree of the reaction and the reaction is considered to be substantially complete when the pressure no longer decreases with time.

It should be understood that the ethoxylation procedure serves to introduce a desired average number of ethylene oxide units per mole of alcohol ethoxylate. For example, treatment of an alcohol mixture with 3 moles of ethylene oxide per mole of alcohol serves to effect the ethoxylation of each alcohol molecule with an average of 3 ethylene oxide moieties per mole alcohol moiety, although a substantial proportion of alcohol moieties will become combined with more than 3 ethylene oxide moieties and an approximately equal proportion will have become combined with less than 3. In a typical ethoxylation product mixture, there is also a minor proportion of unreacted alcohol.

Specific alcohol ethoxylate surface active compounds which can be used in the composition of the present invention include ethoxylated fatty alcohols, preferably linear primary or secondary monohydric alcohols with C₈ to C₁₆, preferably C₁₂ to C₁₅, alkyl groups and an average of 1 to 12, preferably 5 to 12, moles of ethylene oxide per mole of alcohol, and ethoxylated alkylphenols with C₈ to C₁₂ alkyl groups, preferably C₈ to C₁₀ alkyl groups and an average of 1 to 12 moles of ethylene oxide per mole of alkylphenol.

A preferred class of alcohol ethoxylates may be represented by the condensation product of a fatty alcohol having from 12 to 15 carbon atoms and from 5 to 12 moles of ethylene oxide per mole of fatty alcohol. Suitable species of this class of ethoxylates include: the condensation product of C₁₂-C₁₅ oxo-alcohols and 7 moles of ethylene oxide, for example NEODOL 25-7 ethoxylate (available from Shell Chemical Company); the condensation product of narrow cut C₁₄-C₁₅ oxo-alcohols and 7 moles of ethylene oxide per mole of fatty (oxo) alcohol, for example NEODOL 45-7 ethoxylate; and the condensation of a narrow cut C₁₂-C₁₃ fatty (oxo)alcohol and 6.5 moles of ethylene oxide per mole of fatty alcohol, for example NEODOL 23-6.5 ethoxylate. The fatty oxo-alcohols, while primarily linear, can have, depending upon the processing conditions and raw material olefins, a certain degree of branching. A degree of branching in the range from 15% to 50% by weight is frequently found in commercially available oxo-alcohols.

### Component c)

A liquid surface active composition consisting of only components a) and b) may have an unacceptably high viscosity. In order to reduce the viscosity, the composition of this invention may also contain an additive, component c), which is triethanolamine or a diol comprised of carbon, oxygen, and hydrogen atoms and which has a molecular weight of from 75 to 225, preferably from 100 to 160. Preferably, the diol is comprised of only carbon, oxygen, and hydrogen atoms. Polymeric materials such as poly(ethylene) glycol are not diols within the scope of this invention. Preferably, component c) is present in the liquid surface active composition in an amount from at least 4 percent by weight, preferably at least 6, more preferably at least 8, from 4 to 20, preferably from 8 to 16 weight percent, based on the total composition.

In a highly preferred embodiment of this invention, it is important that the composition be flowable at 40° C. or less, and thus have a flow point of 40° C. or less, so that the composition will flow out of a container when desired. The “flow point” as used herein is defined as the lowest temperature at which a liquid will flow out of a container in a reasonable time when the container is inverted. A “reasonable time” may be considered no more than one hour, preferably no more than one minute. A test for flowability to determine the flow point is described below in the examples. Alcohol ethoxysulfates generally become increasingly thermally unstable as the temperature increases. It would be very useful if the flow point of the composition was 40° C. or less.

In this highly preferred embodiment wherein the flow point may be 40° C. or less and the composition may flow easily from its container, component c) may be selected from the group consisting of diethylene glycol, triethylene glycol, tetraethylene glycol (molecular weight—222) and a mixture of 1,3-propanediol and triethanolamine, preferably diethylene glycol (molecular weight—106) and triethylene glycol (molecular weight—150), most preferably triethylene glycol.

If the amount of the additive is less than 4 weight percent, then the composition does not flow at 40° C. or less. If the amount of the additive is more than 20 weight percent, then no additional benefit in improving flow properties is achieved. Thus, more than 20 percent by weight of component c) can be used unless other properties are adversely affected.

### Water

The liquid surface active composition may also contain water. The amount of water generally utilized in the composition is less than 15 percent by weight of the composition, preferably less than 10 percent by weight, more preferably less than 7 percent by weight, and most preferably less than 5 percent by weight, but preferably not less than 1 percent by weight. The amount of water can be controlled most efficiently with a neutralizing agent which preferably is an anhydrous base, such as for example, triethanolamine or monoethanolamine. However, through drying or through addition of water, the amount of water can also be controlled in systems prepared with alkali metal neutralizing agents. The desired amount of water can be readily determined by one of ordinary skill in the art with a minimal amount of routine experimentation.

In another embodiment, the amount of components b) and c) together may range from 20 to 50, preferably 24 to 40, percent by weight of the total composition. In one embodiment, the liquid compositions of the invention may have a surface active material content, i.e., the percentage of alcohol ethoxylate plus the percentage of alcohol ethoxysulfate, of at least 80 percent by weight of the total composition, alternatively at least 85 percent by weight, and alternatively at least 90 percent by weight. The compositions may also be substantially free, typically less than 3 percent by weight, of organic solvents, including alcoholic solvents and especially lower alcoholic solvents having from 1 to 5 carbon atoms.

The preparation of the liquid surface active compositions of the invention can be accomplished by mixing the components together in any manner. It is generally preferred, however, that the unneutralized alcohol ethoxysulfate product (i.e., the organic sulfuric acid ester resulting from the sulfation reaction) be added to a well-stirred mixture of alcohol ethoxylate and a concentrated base such as, for example, aqueous 50% sodium hydroxide. Other suitable bases include potassium hydroxide, ammonium hydroxide, triethanolamine and monoethanolamine. The additive may be added after the neutralization, but preferably it is added during neutralization to get improved mixing.

The liquid surfactant compositions of the invention may be utilized in a variety of detergent applications. The liquid surfactant compositions may be adsorbed at relatively low temperatures, 50° C. or less, onto other (solid) detergent ingredients well known in the art such as, for example, sodium carbonate, in order to form dry detergent powders. The liquid surfactant compositions may also be added to water along with other (liquid) detergent ingredients well known in the art to form liquid detergents.

Detergent compositions may be made with the liquid surface active compositions of the present invention. Methods for making them are described in U.S. Pat. No. 5,209,874 which is herein incorporated by reference in its entirety.

The invention will be described below by the following examples which are provided for purposes of illustration and are not to be construed as limiting the invention.

### EXAMPLES

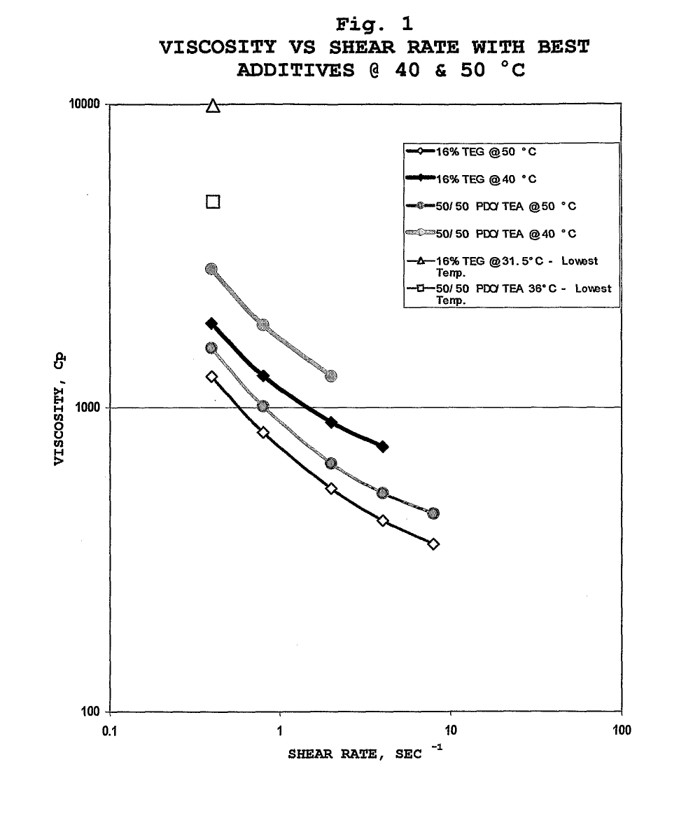

The alcohol ethoxysulfate used in the following experiments was NEODOL 25-3S, a sodium salt of NEODOL 25-3 alcohol ethoxylate having an average of 3 ethylene oxide groups per molecule and made from NEODOL 25 alcohol. The alcohol ethoxylate used in the experiments was NEODOL 25-9 alcohol ethoxylate which has an average of 9 ethylene oxide groups per molecule and is also made from NEODOL 25 alcohol. NEODOL is a registered trademark. The liquid surface active compositions in these examples were prepared by maintaining a constant level of the alcohol ethoxysulfate of 60 weight percent and 8 percent water. The reference sample was a 60 weight percent alcohol ethoxysulfate/32 weight percent alcohol ethoxylate/8 weight percent water mixture. The initial experiments were carried out by substituting one-third and one-half of the alcohol ethoxylate with propylene glycol to achieve 60/24/8/8 weight percent and 60/16/16/8 weight percent mixtures, respectively. Aqueous solutions of alcohol ethoxysulfates were mixed with the alcohol ethoxylate and additives in the desired amounts and then dried in a microwave oven to achieve the desired composition. The desired values for viscosity could not be achieved with these blends. A viscosity of greater than 10,000 millipascal seconds (mPa·s) was realized at 40° C. with a corresponding steep slope versus shear rate, i.e., viscosity increased to extremely high levels at low shear rates (see Table 1 and FIG. 1).

The viscosities of the samples were measured at varying temperatures and shear rates using a Brookfield DV-II+ viscometer. The Brookfield DV-II+ viscometer measures fluid parameters of shear stress and viscosity at given shear rates. The principal of operation of the viscometer is to drive a spindle (which is immersed in the test fluid) through a calibrated spring. The viscous drag of the fluid against the spindle is measured by the spring deflection. Spring deflection is measured with a rotary transducer. The digital display displays the viscosity in centipoise (cP).

Other additives were then substituted for the propylene glycol in the four component composition to obtain 60 weight percent alcohol ethoxysulfate (AES), 16 weight percent alcohol ethoxylate (AE), 16 weight percent of the additive, and 8 weight percent water systems. 35 gram mixtures were prepared by first mixing all of the components together, adjusting the pH, and then heating the sample with short bursts of microwave energy to remove excess water and achieve the correct amounts of components in the sample. After the microwave part of the preparation, the activity of the anionic component of the mixture (the AES) was confirmed by using mixed indicator titration by a standard ASTM test method, D-3049-83a. While the AES portion was at or close to 60 weight percent, the other components were assumed to be at the desired concentrations based on the initial ratios present.

As shown in Table 1, the AES percentages were very consistent and provided samples that were similar in component concentrations allowing for a valid comparison. The best additive was found to be triethylene glycol which provided a low flow point temperature of 31.5° C. and the lowest viscosity range at 40° C. The next best system was a 50/50 1,3-propanediol/triethanolamine system with a low flow point of 36° C. The comparative polymeric material, 200 molecular weight poly(ethylene)glycol, did not lower the viscosity or the flow point nor did the comparative glycerine and monoethanolamine. The blends of these materials with one of the additives of this invention did show a decrease in viscosity and flow point.

The efficacy of the triethylene glycol was confirmed by using a simple bottle experiment at 40° C. in an oven. A 2 fluid ounce (56.8 milliliters) bottle with an unrestricted opening and containing the composition with triethylene glycol was turned over and it was observed that a smooth product drained from the container at 40° C. in less than 1 minute. The 1,3-propanediol/triethanol amine sample was also tested by this method and good flowability was found but the composition did not fully drain from the container at 40° C. A sample containing no additive did not flow at all at a temperature of 60° C.

TABLE 1
AES/AE/Additive/Water Compositions

| | | Additive | | | | | |
|---|---|---|---|---|---|---|---|
| | | concentration | | Flow Point | VISCOSITY RANGE, mPa · s | | |
| ADDITIVE | Molecular Weight | (wt %) | AES (wt. %) | ° C. | 40° C. | 50° C. | 60° C. |
| 0 | | 0 | 58.6 | None | >10,000 | >10,000 | **** |
| Propylene Glycol (PG) | 76 | 8 | 59.2 | 43 | 8500 | 4000-7300 | **** |
| PG* | 76 | 12 | 59.7 | None | >10,000 | >10,000 | **** |
| PG | 76 | 16 | 62.0 | 36 | 4000-7000 | 1600-5800 | **** |
| Glycerine | 92 | 16 | 59.3 | None | >10,000 | >10,000 | >10,000 |
| (Comparative) | | | | | | | |
| PG/Glycerine | 84 | 4/4 | 59.2 | 47 | >10,000 | 9000-10,000 | 5000-7000 |
| (Comparative) | | | | | | | |
| TEA (same day)** | 149 | 16 | 60.4 | >60 | 800-980 | 400-500 | **** |
| Triethanolamine | | | | | | | |
| TEA (next day) | 149 | 16 | 60.4 | 42 | **** | 4900-7800 | 3700-4900 |
| Triethanolamine | | | | | | | |
| PG/TEA | 113 | 8/8 | 59.8 | None | >10,000 | 5000-8600 | **** |
| Hexylene Glycol | 118 | 16 | 61.5 | 44.5 | >10,000 | 5000-8500 | **** |
| MEA Monoethanolamine | 61 | 16 | 60.1 | None | **** | >10,000 | >10,000 |
| (Comparative) | | | | | | | |
| TEG | 150 | 16 | 59.4 | 31.5 | 740-1900 | 360-1300 | **** |
| Triethylenelglycol | | | | | | | |
| MEA/TEG | 79 | 16/4 | Added | 47 | **** | 2750-8000 | 200-300 |
| | | | To cup | | | | |
| PEG*** (200 MW) | 200 | 16 | 60.6 | None | **** | **** | >10,000 |
| Poly (ethylene) | | | | | | | |
| glycol (Comparative) | | | | | | | |
| PDO | 76 | 16 | 60.4 | 43 | 4150-8640 | 430-650 | 227-310 |
| 1,3 Propanediol | | | | | | | |
| PDO (Repeat) | 76 | 16 | 60.4 | 46 | **** | 421-665 | 218-300 |
| PDO/TEA | 113 | 8/8 | 60.4 | 36.4 | 1194-2910 | 448-1580 | 217-1210 |

*We have no explanation as to why the 12% PG composition produced such poor results.
**The first day measurements were probably incorrect because of incomplete mixing which was resolved by the next day.
***PEG is a condensation polymer of ethylene glycol.
****Not determined.

FIG. 1 includes detailed viscosity/shear rate plots for the triethylene glycol and 1,3-propanediol/triethanol amine systems in the temperature range of interest. The triethylene glycol provides the lowest viscosity at 40° C. and the lowest flow point temperature, 31.5° C. It can be seen that the viscosity goes up very quickly at lower shear rates.

It is desirable to have a low shear rate and low viscosity to prevent the composition from sticking in the container. It can be seen from FIG. 1 that the 16 weight percent triethylene glycol solution is the only one which exhibits a viscosity of less than 1300 millipascal seconds at a relatively low shear rate of 0.3 seconds⁻¹ at the temperature of interest, 40° C.

1. A liquid surface active composition which is comprised of:
a) at least 40 percent by weight of the total composition of an alcohol ethoxysulfate;
b) at least 10 percent by weight of the total composition of an alcohol ethoxylate;
c) at least 4 percent by weight of the total composition of an additive which is selected from the group consisting of triethanolamine, diols comprised of carbon, oxygen, and hydrogen atoms and which has a molecular weight of from 75 to 225, and a mixture of 1,3-propanediol and triethanolamine; and
d) water.

2. The composition of claim 1 which comprises from 40 to 70 percent by weight of the total composition of component a), from 10 to 50 percent by weight of the total composition of component b), and from 8 to 16 percent by weight of the total composition of component c).

3. The composition of claim 1 wherein the additive is selected from the group consisting of diethylene glycol, triethylene glycol, tetraethylene glycol, and a mixture of 1,3-propane diol and triethanolamine.

4. The composition of claim 1 wherein the molecular weight of the diol is from 100 to 160.

5. The composition of claim 1 wherein the additive is diethylene glycol or triethylene glycol.

6. The composition of claim 1 wherein the additive is triethylene glycol.

7. The composition of claim 1 wherein the alcohol ethoxysulfates of the composition have the chemical formula
R′—O—(CH₂—CH₂O)ₓ—SO₃M (I)
wherein R′ is a straight chain or branched chain alkyl group having in the range of from 8 to 18 carbon atoms or an alkyl aryl group having an alkyl moiety having from 8 to 12 carbon atoms, x represents the average number of oxyethylene groups per molecule and is in the range of from 1 to 12, and M is a cation selected from an alkali metal ion, an ammonium ion, and mixtures thereof.

8. The composition of claim 1 wherein the alcohol ethoxylates of the composition have the chemical formula
R—O—(CH₂—CH₂O)ₙ—H (II)
wherein R is a straight chain or branched chain alkyl group having in the range of from 8 to 18 carbon atoms or an alkyl aryl group having an alkyl moiety having from 8 to 12 carbon atoms, and n represents the average number of oxyethylene groups per molecule and is in the range of from 1 to 12.

9. The composition of claim 1 8 wherein the amount of components b) and c) together is from 20 to 50 percent by weight of the total composition.

10. The composition of claim 1 wherein the amount of component a) and component b) is at least 80 percent by weight of the total composition.

11. The composition of claim 6 wherein the viscosity of the composition at 40° C. is less than 1300 millipascal seconds at a shear rate of 0.3 seconds⁻¹.

12. A detergent composition containing the liquid surface active composition of claim 1 and other detergent ingredients.

13. A process for making a detergent composition which comprises mixing the liquid surface active composition of claim 1 with other detergent ingredients.
